(19) United States
(12) Patent Application Publication
(10) Pub. No.: US 2026/0321443 A1
(43) Pub. Date: Oct. 15, 2026

(54) COMPONENT FOR COMPRESSING FUEL

(71) Applicant: First Light Fusion Limited, Yarnton, Oxfordshire (GB)

(72) Inventors: Jonathan Skidmore, Yarnton, Oxfordshire (GB); Nicolas Niasse, Yarnton, Oxfordshire (GB); Nicholas Hawker, Yarnton, Oxfordshire (GB)

(21) Appl. No.: 19/482,933

(22) PCT Filed: May 16, 2024
(86) PCT No.: PCT/GB2024/051276

§ 371 Date: Nov. 10, 2025

(30) Foreign Application Priority Data
May 17, 2023 (GB) 2307372.9

(51) Int. Cl. G21B 3/00

(52) U.S. Cl. CPC G21B 3/008

(57) ABSTRACT

Please replace the abstract as originally filed with the following replacement abstract: A component for compressing fuel using an input shockwave. The component includes a body having a recess wall defining a recess, an input for inputting the input shockwave into the component, and a target element within the recess. The target element includes a fuel-containing material. The component is configured to manipulate the input shockwave to provide a localised concentration of energy within the target element.

### CROSS-REFERENCE TO RELATED APPLICATION(S)

This application is the U.S. national phase under 35 U.S.C. § 371 of International Application No. PCT/GB 2024/051276 filed on May 16, 2024, and claims the benefit of United Kingdom Patent Application No. 2307372.9 filed on May 17, 2023, wherein the entire disclosures of the foregoing applications are hereby incorporated by reference herein.

### TECHNICAL FIELD

This invention relates to a component for compressing fuel using an input shockwave, in particular to methods and apparatuses for compressing a fuel-containing material by producing high localised concentrations of energy by manipulating an input shockwave.

### BACKGROUND

It has been shown in WO 2011/138622 that an interaction between a shockwave in a non-gaseous medium and a gaseous medium can generate a high speed transverse jet of the non-gaseous medium that moves through the gaseous medium. This results in the jet impacting on and trapping a volume of the gaseous medium, which gives rise to an intense concentration of energy within the gas.

The present invention aims to provide alternative techniques for producing localised energy concentrations.

### SUMMARY

When viewed from a first aspect, the invention provides a component for compressing fuel using an input shockwave, the component comprising:
a body comprising a recess wall defining a recess;
an input for inputting the input shockwave into the component; and
a target element within the recess;
   wherein the target element comprises a fuel-containing material;
wherein the component is configured to manipulate the input shockwave to provide a localised concentration of energy within the target element.

The invention thus provides a component that manipulates (e.g. focuses) an input shockwave to be incident upon a target element within the component, when a shockwave is input into the component, causing a localised concentration of energy to be provided within the target element. This may cause the fuel in the volume to collapse, creating high pressures and temperatures within the fuel. Where the fuel is a fusionable fuel, the compression of the fuel may lead to nuclear fusion.

The component includes a body in which is defined a recess. The component comprises a target element within the recess. The target element comprises (e.g. is formed from, e.g. consists of) a fuel-containing material. Thus the recess contains a volume of fuel-containing material.

It will be understood that the term “fuel-containing material” refers to a material that is not solely fuel. Rather, a fuel-containing material comprises a material (e.g. a bulk or lattice material, or a powder) that is not fuel, in or among which fuel is contained (e.g. as part of a mixture or compound). In embodiments, the fuel-containing material comprises fuel that is (e.g. uniformly) dispersed throughout the material. In embodiments, the fuel-containing material comprises a non-localised fuel.

In some embodiments, the bulk material is non-fusionable (e.g. is substantially inert).

In some embodiments, the fuel-containing material is a compound, e.g. with the fuel ionically or covalently bonded in the compound. Thus, in some embodiments, the fuel-containing material comprises a hydride such as water, lithium hydride, aluminium hydride or ammonia. In some embodiments, the fuel-containing material comprises a deuteride such as deuterated water, lithium deuteride, aluminium deuteride, lithium aluminium deuteride or deuterated ammonia. In some embodiments, the fuel-containing material comprises a tritiide such as tritiated water, lithium tritiide, aluminium tritiide or tritiated ammonia. In some embodiments, the fuel within the fuel-containing material comprises a mixture of deuterium and tritium.

In some embodiments, the fuel-containing material comprises a hydrocarbon (e.g. deuterated or tritiated hydrocarbon). It will be understood that in a (e.g. deuterated or tritiated) hydrocarbon (or other hydrogen, deuterium or tritium containing compound), the fuel is provided by the hydrogen, deuterium or tritium atoms or ions in the compound and the remaining atoms or ions are the bulk material.

In some embodiments, the fuel-containing material comprises a bulk material (and a fuel), wherein the bulk material is not (does not comprise) fuel (e.g. any type of fuel, not just the fuel of the fuel-containing material), among which the fuel is contained, wherein the fuel is not chemically bonded to the bulk material. In some embodiments, the fuel containing material comprises a non-stoichiometric material, e.g. comprising a bulk material (that is not fuel) and fuel.

In some embodiments, the fuel-containing material is a fuel-doped material, e.g. a material into which the fuel (e.g. fuel atoms or ions) replaces atoms or ions, for example, in the material, e.g. in a (e.g. crystalline) lattice. In some embodiments, the fuel-containing material comprises fuel-doped metal, such as hydrogen-doped palladium, hydrogen-doped aluminium, hydrogen-doped lithium, hydrogen-doped zirconium, hydrogen-doped hafnium, deuterium-doped palladium, deuterium-doped aluminium, deuterium-doped lithium, deuterium-doped zirconium, deuterium-doped hafnium, tritium-doped palladium, tritium-doped aluminium, tritium-doped lithium, tritium-doped zirconium and/or tritium-doped hafnium.

It will be understood that in a fuel-doped material, the fuel is provided by the dopant (e.g. the hydrogen, deuterium or tritium atoms or ions that are inserted into the material) and the remaining atoms or ions are the bulk (or lattice) material. It will further be understood that, in a fuel-doped material, the fuel is not chemically bonded to the bulk material. This may be advantageous since the lack of chemical bonds may enable the fuel to be ‘swept up’ by the shockwave as it propagates through the fuel-containing material. The fuel within the target element may therefore be accelerated ahead of the shockwave propagating through the target element (e.g. owing to the lighter mass of the fuel particles compared to the mass of the remaining (e.g. bulk or lattice) target element material). This helps to increase the density of the fuel at the focus of the shockwave in the target element.

In some embodiments, the fuel-containing material is a mixture containing the fuel, e.g. the fuel may be located in interstitial gaps in the (e.g. bulk or lattice) material, such that the fuel-containing mixture is a mixture of the (e.g. bulk or lattice) material and the fuel. It will be understood that, in a mixture, the (e.g. bulk or lattice) material, and the fuel are not chemically bonded. Fuel-containing materials comprising a mixture may be advantageous since the lack of chemical bonds may enable the fuel to be ‘swept up’ by the shockwave as it propagates through the fuel-containing material. The fuel within the target element may therefore be accelerated ahead of the shockwave propagating through the target element (e.g. owing to the lighter mass of the fuel particles compared to the mass of the remaining (e.g. bulk or lattice) target element material). This helps to increase the density of the fuel at the focus of the shockwave in the target element.

In some embodiments, the fuel-containing material (e.g. the bulk or lattice material) comprises a non-gaseous material, e.g. a liquid. In some embodiments, the fuel-containing material (e.g. the bulk or lattice material) comprises a non-fluid material, such that it substantially holds its own shape (at normal temperatures and pressures). By using a bulk material that substantially holds its own shape, target elements having different shapes which may be advantageous for manipulating a shockwave can be created. If the bulk material is able to hold its own shape, then the need for casings can be removed or at least reduced. This may be advantageous since casings may negatively affect the propagation of the shockwave (e.g. by reflecting a portion of the shockwave, or resulting in an unwanted shockwave manipulation due to the boundary between the casing and the bulk material. In some embodiments, the fuel-containing material comprises a semi-solid (e.g. a gel or foam) fuel-containing material. In some embodiments, the fuel-containing material comprises a solid fuel-containing material. In some embodiments the fuel-containing material comprises a fuel-containing metal, e.g. fuel-containing palladium, aluminium or lithium.

The fuel may comprise any suitable and desired fuel. In some embodiments, the fuel comprises a fusionable fuel, e.g. hydrogen, deuterium and/or tritium. Thus, in some embodiments, the component is configured to manipulate the input shockwave to provide a localised concentration of energy within the target element that is suitable for initiating fusion, e.g. to generate a localised concentration of energy of sufficiently high temperature and/or pressure.

In use, the input shockwave propagates through the component, e.g. through the recess (and, e.g., the body), from the input to the target element. The (e.g. shape and/or the material of the) body and/or the recess are designed to manipulate (e.g. focus, e.g. modify the shape and/or intensity of) the shockwave as it passes through the (recess of the) component towards the target element.

The (e.g. recess of the) component thus helps to amplify the intensity of the input shockwave (and thus the concentration of the energy) between the input and the target element, as the shockwave passes through the component.

In this way, a localised energy concentration (a higher concentration of energy compared to the energy concentration of the input shockwave) is produced within the target element. As such, the shockwave within the target element may have a greater (e.g. energy) intensity than the input shockwave and/or a different shape from the input shockwave. The localised energy concentration of the shockwave compresses the fuel in the target element, potentially leading to collapse, and in the case of fusionable fuel, potentially leading to fusion.

When the manipulated (e.g. focused) shockwave is incident upon on the target element, the fuel within the (fuel-containing material of the) target element may be accelerated ahead of the shockwave propagating through the target element (e.g. owing to the lighter mass of the fuel particles compared to the mass of the remaining (e.g. bulk) target element material). This helps to increase the density of the fuel, e.g. at the focus of the shockwave in the target element.

As the shockwave propagates through the target element, it may promote species separation within the fuel-containing material, thus helping to draw the fuel out of the remaining (e.g. bulk) target element material. Species separation may increase the fuel compression and/or the density of the fuel, e.g. at the focus of the shockwave in the target element.

In embodiments, the fuel-containing material (e.g. the bulk material) may be a non-fluid. Providing the fuel in the target element as a fuel-containing material that is a non-fluid allows the fuel, which may be a fluid (e.g. gas) in its isolated form, to be formed in (and retain) the shape of the target element. This aids manufacturing and assembly of the component, e.g. because this does not have to contend with a fluid fuel that needs to be retained in the component (before, during or after manufacture) or pumped into the component (e.g. after manufacture).

In this latter case, a channel for pumping fuel into the component may need to be provided, which adds to the complexity of the component, e.g. the target element may have to be formed as a split or jointed part to accommodate the channel (e.g. fluid fuel fill tube). This structure of the target element that may be needed to provide or accommodate a channel may also affect the propagation of the shockwave and the concentration of energy towards the target element. This may be avoided by forming the target element from a fuel-containing material, such that a fluid channel for fuel does not need to be provided. Similarly, an associated fluid fill system, to provide the fluid fuel to the component, is not needed.

Operation of the component may also be simplified owing to not have to fill the component with a fluid fuel before the input shockwave is inputted to the component. This may also reduce the time taken to set up and operate a system including the component, which may help to increase the repetition rate of operation.

Providing the fuel in the fuel-containing material also helps to distribute the fuel throughout the material of the target element. Providing a non-localised fuel helps to accommodate misalignment that may occur in the input shockwave, e.g. if the input shockwave does not propagate exactly in the direction parallel to a central axis of the component. This is because the shockwave may still be focused to a point within the target element.

The body may be provided in any suitable and desired way. In some embodiments, the body comprises (e.g. is formed from, e.g. consists of) a first material. Preferably the body is a unitary body, e.g. formed from the first material. Thus, preferably the body is formed as a single part.

The first material may comprise any suitable and desired material, in which a recess may be formed. Preferably the first material is a solid. Preferably the first material is a metal, e.g. a refractory metal, e.g. tantalum. Such materials are resistant to high temperatures and pressures, have a high shock-impedance and hardness.

The body comprises (is shaped to define) a recess, e.g. in a surface of the body. Thus, the body comprises a wall that defines the recess in the body.

The recess may have any suitable and desired shape. In some embodiments the recess wall defining the recess comprises a curved portion. In some embodiments the recess is concave. For example, the recess may have an opening (e.g. proximal to the input of the component) in an outer surface of the body that has a greater dimension (e.g. is wider) than a base of the recess.

In some embodiments the recess is bowl-shaped, e.g. substantially hemispherical.

In some embodiments the recess comprises a void (e.g. substantially a vacuum), within which the target element is provided, e.g. such that the target element is surrounded by the void. In some embodiments the recess contains (e.g. is filled with) a second material (e.g. that surrounds the target element). Preferably the second material has a lower shock-impedance than the shock-impedance of the first material.

Filling the recess with a material helps to support and position the target element within the recess. This may mean that it is not necessary to provide a separate support structure for the target element, which could interfere with the dynamics of the shockwave as it propagates through the component.

Filling the recess with a (second) material having a lower shock-impedance than the (first) material of the body helps to control the manipulation (e.g. focusing) of the shockwave as it propagates through the component, in particular the reflection of the shockwave from the wall(s) of the recess, which may be enhanced by the difference in shock-impedance of the first and second materials.

The recess may be filled with any suitable and desired material. In some embodiments, the recess is filled with a polymer, e.g. polymethyl methacrylate (PMMA).

In some embodiments the (fuel-containing material of the) target element has a higher shock-impedance than the (material of the) recess (e.g. the second material).

The input of the component may be provided in any suitable and desired way, to input the shockwave into the component. For example, nature of the input may depend on how the shockwave is generated.

In some embodiments, the input of the component is provided by an outer surface of the body and/or the outer surface of the (second material of the) recess. Thus, the body and/or the (second material of the) recess may comprise (e.g. together form) an input face, e.g. an outer surface of the body and outer surface of the second material of the recess (the surface of the second material that is distal from the wall(s) of the recess) may be co-planar.

Preferably the input face extends in one or more directions about (e.g. substantially perpendicular to) a central (longitudinal) axis of the (e.g. body of the) component. One or more (e.g. all) of the input face, the body, the recess and the component may be (e.g. rotationally) symmetrical about the central axis.

In use, the (e.g. input face of the) input may be arranged to be impacted, e.g. by a projectile, e.g. directed along the central axis so to be incident upon the input (face). Thus, in some embodiments, the input shockwave may be generated in the component, for example, by the (e.g. input face of the) input (e.g. the body and/or the recess material) being struck or impacted (e.g. by a projectile). In some embodiments, the input shockwave may be generated externally from the component, and, e.g., be received by (e.g. be incident upon) the input of the component.

In some embodiments, the (e.g. input face of the) input comprises a concave portion. In embodiments, the (e.g. entire) input face is concave and, e.g., continuously curved. Such embodiments may be used with a projectile (e.g. having a substantially flat impacting surface) that is arranged to strike the (e.g. input of the) component to generate a shockwave having a curved shock-front in the (e.g. body and/or recess of the) component.

In some embodiments, the (e.g. input face or layer of the) input comprises a convex portion. In embodiments, the (e.g. entire) input face or layer is convex. Such embodiments may be configured to work with a projectile which strikes the (e.g. input of the) component to generate a shockwave. A convex input face may not help to curve the shockwave, but a convex input face may be less sensitive to projectile tilt (e.g. the projectile not being perfectly aligned with the input face) and so may be preferable to a concave face in systems where the angle of the projectile at the input is less predictable.

In some embodiments, the (e.g. input face of the) input comprises a flat portion. In embodiments, the (e.g. entire) input face is flat. Such embodiments may be used with a projectile having a curved (e.g. concave) impacting surface that is arranged to strike the (e.g. input of the) component to generate a shockwave having a curved shock-front in the (e.g. body and/or recess of the) component.

In embodiments, the (e.g. input face or layer of the) input has a convex face. Such embodiments may be configured to be used with a projectile having a corresponding concave impacting surface which is arranged to strike the (e.g. input of the) component such that the impacting surface of the projectile and the input face are aligned (e.g. the impacting surface is complementary to the input face) when the projectile impacts the component. Such embodiments may help to increase the energy coupling from the projectile into the component.

Although some examples have been described herein, all possible input face and projectile impacting face convex/concave combinations are envisaged.

The target element may be formed in any suitable and desired way. In some embodiments the target element is a unitary element, formed from the fuel-containing material. Thus, preferably the target element is formed as a single part.

The target element may be arranged within the recess in any suitable and desired way. When the recess contains (e.g. is filled with) a second material, preferably the target element is contained within (e.g. surrounded by) the second material. Preferably the second material and the target element are contiguous (e.g. over the majority or substantially all of the surface area of the target element), such that there is substantially no gap between the second material and the target element. Embedding the target element in the second material may help the shockwave to be transmitted from the second material into the target element.

In some embodiments, the (e.g. base of the) target element is spaced from the recess wall (e.g. base) defining the recess, such that some of the volume of the recess (e.g. the void or the second material) is between the target element and the recess. In some embodiments, the (e.g. base of the) target element is in contact with the (wall (e.g. base) of the) recess, such that there is none of the recess (e.g. none of the void or the second material) between the target element and the recess.

In some embodiments, the component comprises an (e.g. shaped) impedance matched element between the (e.g. base of the) target element and the (e.g. base of the) recess wall. This may help to suppress the formation of a high pressure jet and thus help to concentrate the energy of the manipulated shockwave into the target element.

In some embodiments, the recess comprises a depression (e.g. defined in the recess wall) distal from the component input, e.g. on the opposite side of the target element from the input. This may help to suppress the formation of a high pressure jet and thus help to concentrate the energy of the manipulated shockwave into the target element.

The target element may comprise any suitable and desired shape. The target element may have a circular cross-section, e.g. in a plane parallel to (e.g. containing) the central axis of the component and/or in a plane perpendicular to the central axis of the component. The target element may be spherical.

In some embodiments, the target element is non-spherical. In such embodiments, the target element may help to further manipulate (e.g. focus) the shockwave as it propagates into the target element.

In some embodiments, the component comprises a central axis and is configured to receive an input shockwave propagating in a direction parallel to the central axis, wherein the target element has a first maximum dimension parallel to the central axis, and a second maximum dimension perpendicular to the central axis, wherein the first maximum dimension is greater than the second maximum dimension. In such embodiments, the target element may help to further manipulate (e.g. focus) the shockwave as it propagates into the target element. For example, the target element may act to spherically focus an incoming planar shockwave by slowing the portion of the shockwave propagating along the central axis of the component.

In some embodiments the target element has an oval cross-section, e.g. in a plane parallel to (e.g. containing) the central axis of the component. Preferably the target element is rotationally symmetrical, e.g. about the central axis of the component.

Thus, in some embodiments, the target element is substantially ovoidal (egg-shaped). An ovoidal target element may help to further manipulate (e.g. focus) the shockwave as it propagates into the target element.

Preferably one end of the ovoidal target element is more tapered and the other end is more rounded. Preferably the target element has a maximum dimension (e.g. the longest dimension (major axis) of the ovoid) that is parallel (e.g. coaxial) with the central axis of the component. Preferably the more tapered end of the ovoid is proximal to the input of the component. Preferably the more rounded end of the ovoid is proximal to the base of the recess.

In some embodiments the target element comprises a substantially flat face, e.g. proximal to and/or parallel with the input of the component, e.g. parallel with the outer surface of the recess. In some embodiments the target element has straight sides, e.g. parallel with the central axis of the component. In some embodiments the target element has a circular cross-section, in a plane perpendicular to the central axis of the component. In some embodiments the target element has a convex (e.g. rounded, e.g. substantially hemispherical) base, e.g. proximal to the base of the recess.

Thus, in a preferred set of embodiments, the target element comprises a flat face and a cylindrical portion proximal to the input of the component, and a rounded (e.g. substantially hemispherical) base proximal to the base of the recess. This shape may be easier to manufacture and assemble than an ovoidal target element.

The target element may be filled with the fuel-containing material (e.g. the target element may be solid) throughout its volume. In some embodiments, the target element comprises a (e.g. hollow) cavity, e.g. defined within (e.g. at the centre of) the target element. Thus, the target element may comprise a (fuel-containing material) shell defining a (e.g. hollow) cavity.

The shell may comprise a wall (or walls) having a thickness. The outer surface of the wall(s) may form the outer surface of the target element. The inner surface of the wall(s) may form the inner surface of the target element (and thus, for example, the bounds of the cavity).

The fuel-containing material of the target element may be arranged to implode into the cavity upon incidence of the input shockwave on the target element. Providing a cavity may help to enhance the compression (and, e.g., collapse) of the fuel-containing material (and thus the fuel), as the shockwave propagates through the target element.

A cavity may provide a volume in which the fuel (e.g. drawn out from the fuel-containing material) is compressed. For example, the shockwave may accelerate the fuel ahead of the compression of the remaining material of the target element and thus the cavity may provide a volume into which the fuel is swept, e.g. before the remaining material of the target element is compressed into the fuel in the cavity.

In some embodiments the cavity comprises substantially a vacuum, e.g. the cavity is substantially evacuated.

In some embodiments the cavity comprises (e.g. contains (e.g. is filled with)) a fuel. The fuel may be provided in any suitable and desired way in the cavity. In some embodiments the cavity comprises (e.g. contains (e.g. is filled with)) a powder. Preferably the powder has a lower average density and/or a lower shock-impedance than the (fuel-containing material of the) target element.

In some embodiments the powder comprises a fuel-containing (e.g. fuel-doped) powder, e.g. the fuel is provided in the powder. In some embodiments the cavity comprises (e.g. contains (e.g. is filled with)) a (e.g. gaseous) fuel or fuel-containing material in the (e.g. interstitial) gaps between the (e.g. fuel-containing) powder. In some embodiments, the fuel-containing powder may be (or may be the same material as) the fuel-containing material.

The powder may comprise any suitable material, e.g. that contains fuel. In some embodiments the powder comprises a (e.g. fuel-containing) metal, e.g. a (e.g. fuel-containing) platinum group metal, e.g. palladium, e.g. fuel-containing palladium. In some embodiments the powder comprises (e.g. fuel-containing) aluminium or lithium.

In some embodiments the powder comprises a (e.g. fuel-doped) metal, e.g. a (e.g. fuel-doped) platinum group metal, e.g. palladium, e.g. fuel-doped palladium. In some embodiments the powder comprises (e.g. fuel-doped) aluminium or lithium.

The fuel, e.g. which the power contains, may comprise any suitable and desired fuel. In some embodiments the fuel comprises a fusionable fuel, e.g. hydrogen, deuterium and/or tritium. The same fuel may be used in the fuel-containing powder and to fill the gaps between the powder. When the cavity comprises a fuel-containing material in the gaps between the powder, the fuel-containing material may be any suitable and desired fuel-containing material, e.g. as outlined herein.

In a preferred set of embodiments, the cavity in the target element contains (e.g. is filled with) deuterium-doped palladium powder and/or a powder whose (e.g. interstitial) gaps are filled with hydrogen, deuterium and/or tritium gas, or any other fuel-containing material.

Having a source of fuel in the cavity of the target element helps to provide additional fuel that can be compressed and heated by the incident shockwave, e.g. by the collapse of the (shell of the) target element.

As outlined above, the outer surface of the (second material of the) recess may form at least part of the input of the component. In some embodiments the component comprises at least one impedance matching layer adjacent to or at the input of the component. In some embodiments, the input of the component comprises the impedance matching layer.

Providing an impedance matching layer, e.g. matching the impedance of an incident projectile, may help to couple the incident shockwave into the component. Thus, as outlined above in relation to the input of the component, the impedance matching layer may be arranged to be impacted by a projectile to generate the input shockwave.

Thus, in some embodiments, the input of the component is provided by (e.g. an outer surface) of the impedance matching layer, e.g. together with an outer surface of the body. In some embodiments, the impedance matching layer extends across the (e.g. opening of the) recess, e.g. between the wall(s) of the body (that form the recess). Thus, the body and/or the impedance matching layer may comprise (e.g. together form) an input face, e.g. an outer surface of the body and outer surface of the impedance matching layer may be co-planar.

The impedance matching layer may be (e.g. rotationally) symmetrical about the central axis of the component. Preferably the impedance matching layer comprises a planar outer surface and/or a planar inner surface. Preferably the impedance matching layer has a uniform thickness, e.g. the outer surface is parallel to the inner surface. Preferably the (e.g. outer and/or inner surface) impedance matching layer is substantially perpendicular to the central axis of the component.

In use, the (e.g. input face of the) input may be arranged to be impacted, e.g. by a projectile, e.g. directed along the central axis so to be incident upon the input (face). Thus, in some embodiments, the input shockwave may be generated in the component, for example, by the (e.g. input face of the) input (e.g. the body and/or the recess material) being struck or impacted (e.g. by a projectile). In some embodiments, the input shockwave may be generated externally from the component, and, e.g., be received by (e.g. be incident upon) the input of the focusing portion.

The impedance matching layer may be formed from any suitable and desired material. In some embodiments, the impedance matching layer has a shock-impedance greater than a shock-impedance of the second material (in the recess). In some embodiments, the impedance matching layer has a shock-impedance substantially equal to a shock-impedance of the body.

Preferably the impedance matching layer is a solid. Preferably the impedance matching layer comprises (e.g. is formed from, e.g. consists of) a metal, e.g. a refractory metal, e.g. tantalum. The impedance matching layer may be formed of the same material as the material of the projectile and/or the body. Thus, the impedance matching layer may have a shock-impedance substantially equal to a shock-impedance of the projectile.

In some embodiments, the target element is connected to (e.g. supported by) the impedance matching layer. For example, the target element may be connected to the inner surface of the impedance matching layer. Attaching the target element to the impedance matching layer may simplify the manufacture and assembly of the component, and may mean that it is not necessary to provide the second material in the recess, e.g. apart from the impedance matching layer and the target element, the recess may comprise a void.

When the target element is connected to the impedance matching layer, it may be convenient for the target element to have a planar face that is connected to (e.g. contiguous with) the (e.g. planar) inner surface of the impedance matching layer.

The invention also provides a method of compressing (e.g. collapsing) fuel using an input shockwave and thus, from a further aspect, the invention provides a method of compressing (e.g. collapsing) fuel using an input shockwave, the method comprising generating the input shockwave at the input of the component according to any one of the aspects or embodiments described herein.

It will be appreciated that this aspect may (and preferably does) include one or more (e.g. all) of the preferred and optional features disclosed herein, e.g. relating to other aspects and embodiments of the invention, as applicable.

For example, the method may comprise generating the input shockwave in the component, for example, by striking or impacting the (e.g. input face of the) input of the component (e.g. by a projectile). In some embodiments, the input shockwave may be generated externally from the component, and, e.g., be received by (e.g. be incident upon) the input of the component. Thus, the method may comprise generating an external shockwave and causing the shockwave to be incident upon (e.g. directing the shockwave towards) the input of the component.

Preferably the shockwave is arranged (allowed) to (at least initially) propagate along a direction parallel to the central (longitudinal) axis of the component. Thus, preferably the shockwave is arranged to be incident upon or is generated in the input of the component in a plane perpendicular to the central (longitudinal) axis of the component, e.g. parallel to a plane of the input of the component.

The invention also provides a system for compressing (e.g. collapsing) fuel using an input shockwave and thus, from a further aspect, the invention provides a system for compressing (e.g. collapsing) fuel using an input shockwave, the system comprising:
a component according to any one of the aspects or embodiments described herein; and
a mechanism for generating the input shockwave at the input of the component.

It will be appreciated that this aspect may (and preferably does) include one or more (e.g. all) of the preferred and optional features disclosed herein, e.g. relating to other aspects and embodiments of the invention, as applicable.

In some embodiments, the mechanism comprises:
a driving mechanism configured to drive a projectile into the component to generate a shockwave at the (e.g. input face of the) input of the component.

The projectile preferably comprises an impacting surface arranged to impact the (e.g. input of the) component.

In some embodiments, the impacting surface of the projectile comprises a substantially flat (e.g. planar) portion. Such projectiles may be used with a component having an input face comprising a concave portion. This may help to generate an input shockwave having a curved shock-front in the component.

In some embodiments, the impacting surface of the projectile comprises a curved (e.g. concave) portion. Such projectiles may be used with a component having an input face comprising a substantially flat portion. This may help to generate an input shockwave having a curved shock-front in the component.

The projectile may comprise any suitable and desired material. In some embodiments, the projectile has a shock-impedance greater than a shock-impedance of the second material (in the recess). In some embodiments, the projectile has a shock-impedance substantially equal to a shock-impedance of the body and/or the impedance matching layer.

Preferably the projectile comprises (e.g. is formed from, e.g. consists of) a solid. Preferably the projectile comprises (e.g. is formed from, e.g. consists of) a metal, e.g. a refractory metal, e.g. tantalum. Thus, the projectile may be formed from the same material as the body and/or the impedance matching layer of the component.

In embodiments the projectile comprises (e.g. is formed from, e.g. consists of) a lower shock-impedance material, e.g. a low density metal, e.g. aluminium, or a lower density material, e.g. PMMA.

In some embodiments, the mechanism for generating a shockwave comprises an explosively driven mechanism, such as a gas gun, configured to drive the projectile into the component. In some embodiments, the mechanism for generating a shockwave comprises an electromagnetic mechanism, such as a pulsed power machine magnetically driven plate flyer, configured to drive the projectile into the component.

In some embodiments, the (e.g. electromagnetic) mechanism for generating a shockwave comprises a direct drive mechanism configured to generate a Lorentz force in an electrode adjacent the component. In such embodiments, the Lorentz force generates a shockwave in the electrode which is transmitted to the input of the component.

In some embodiments, the mechanism for generating a shockwave comprises a laser drive mechanism. The mechanism may comprise an ablator layer adjacent the input of the component and one or more lasers configured to ablate the ablator layer creating a shockwave in the component. In embodiments, the lasers are incident directly on the ablator layer. In embodiments, the lasers are incident on a hohlraum surface, creating X-rays that bathe the ablator material causing it to ablate.

It will be understood that where used herein, the term “shock-impedance” is intended to mean “the pressure which must be applied to a medium in order to impart a unit particle velocity to some of the medium” (Henderson, ‘On the refraction of shock waves’, Journal of Fluid Mechanics, Volume 198, January 1989, pages 365-386). This is equal to the product of the shock speed and the density of the un-shocked material.

The component may have any suitable and desired dimensions, e.g. to be determined by the specific application of the component. In one embodiment the component has a thickness, diameter and/or maximum dimension between 0.1 mm and 100 mm, e.g. between 1 mm and 50 mm, e.g. between 2 mm and 10 mm, e.g. approximately 3 mm, 5 mm or 8 mm.

### BRIEF DESCRIPTION OF DRAWINGS

Certain embodiments of the invention will now be described, by way of example only, with reference to the accompanying drawings, in which:

FIGS. 1a and 1b show a component in accordance with an embodiment of the invention;

FIGS. 2a and 2b show a system incorporating the component of FIGS. 1a and 1b; and

FIGS. 3 to 9 show components in accordance with embodiments of the invention.

### DETAILED DESCRIPTION

Components and systems for compressing (e.g. collapsing) fuel by producing high localised concentrations of energy by manipulating an input shockwave to produce a high pressure quasi-spherical shockwave incident on the fuel will now be described.

It will be understood that where used herein, the terms “top”, “bottom”, “up”, “down”, “side”, “base”, etc., are included for clarity and are intended to refer to the orientation shown in the enclosed Figures. It will be appreciated that, in use, the components and systems may operate in any suitable and desired orientation.

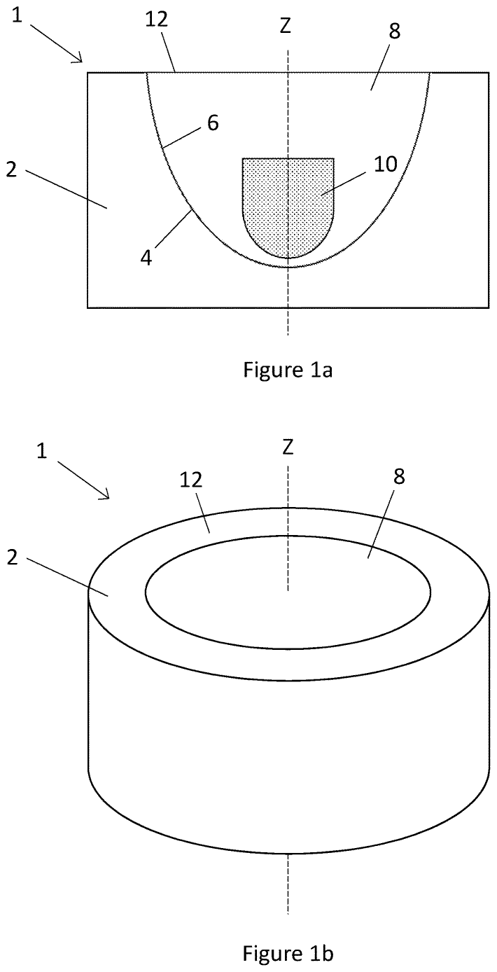

FIGS. 1a and 1b show cross-sectional and perspective views respectively of a component 1 in accordance with an embodiment of the invention.

The illustrated cross-section is taken in a plane containing a central longitudinal axis Z of the component 1. In the illustrated embodiment, the component 1 is rotationally symmetrical about the central axis Z, as can be seen from FIG. 1b. It will be appreciated that, in other embodiments, the component 1 may be cylindrically symmetrical, with FIG. 1a showing a cross-section in a plane perpendicular to the cylindrical axis of the component.

The component 1 comprises three portions: a body 2 that comprises a bowl-shaped recess 4. The recess 4 is defined by recess walls 6, the angle of which varies continuously (e.g. is curved) such that the recess 4 is bowl-shaped. The body 2 is formed of a material having a high shock-impedance. In an exemplary embodiment, the body 2 is formed of tantalum. The body 2 may be formed of other materials, for example other heavy metals, e.g. tungsten, steel, copper or platinum.

The recess 4 is filled with a material 8 having a low shock-impedance material, such as PMMA or epoxy resin. The ratio of the shock-impedances in the high shock-impedance body 2 to the low shock-impedance material 8 filling the recess 4 is preferably large, such that there is a large difference in shock-impedance at the recess walls 6.

A target element 10 is embedded within the material 8, as can be seen from FIG. 1a. The target element 10 has a part-cylindrical shape, with a flat top face, straight sides and a rounded (hemispherical) base, the rounded base having a greater curvature than the base of the recess. The target element 10 is fully surrounded by the material 8 filling the recess 4, such that the target element 10 is spaced from the recess walls 6.

The target element 10 is formed from fuel-containing material which in the illustrated embodiment is palladium that is doped with deuterium. The deuterium is distributed throughout the target element 10 and is thus non-localised. It will be understood that any suitable fuel-containing (e.g. fuel-doped) material may be used.

For example, a fuel-containing material may be selected from the list of: a hydride such as water, lithium hydride, aluminium hydride or ammonia; a deuteride such as deuterated water, lithium deuteride, aluminium deuteride or deuterated ammonia; a tritiide such as tritiated water, lithium tritiide, aluminium tritiide or tritiated ammonia; a hydrocarbon (e.g. deuterated or tritiated hydrocarbon); a fuel-doped metal, such as hydrogen-doped palladium, hydrogen-doped aluminium, hydrogen-doped lithium, deuterium-doped palladium, deuterium-doped aluminium, deuterium-doped lithium, tritium-doped palladium, tritium-doped aluminium or tritium-doped lithium.

The component comprises an input 12. The input 12 is formed by the planar face of the body 2 and the material 8 filling the recess 4.

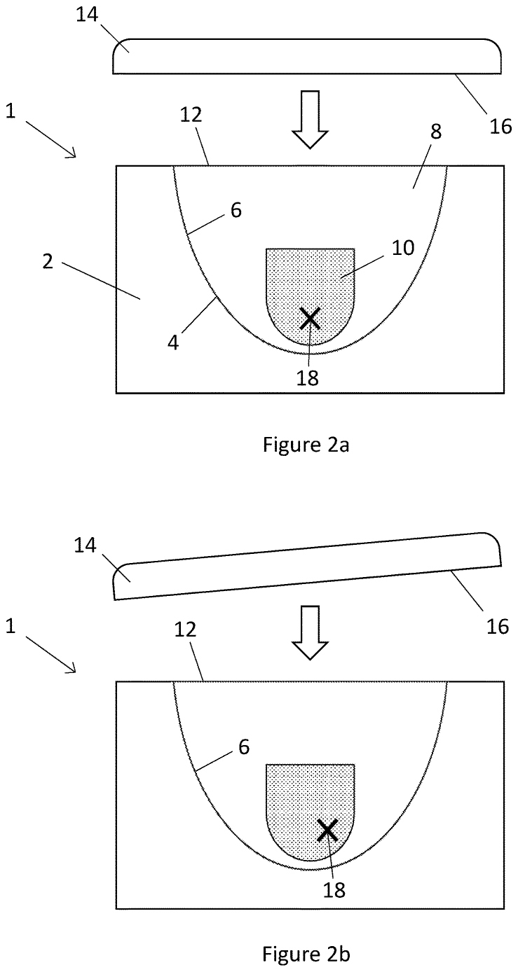

Operation of the component 1 will now be described with reference to FIGS. 1a, 1b, 2a and 2b. FIGS. 2a and 2b show a system in accordance with an embodiment of the invention, incorporating the component 1 shown in FIGS. 1a and 1b.

The input 12 is configured to receive a shockwave. In the embodiment shown in FIG. 2a, the shockwave is generated by striking the input 12 of the component 1 with a disc shaped projectile 14 having a flat impacting surface 16. In the illustrated embodiment, the projectile 14 is at least partially formed of tantalum, but may be formed of other heavy metals such as tungsten, platinum, steel or copper.

After the projectile 14 strikes the input 12 of the component 1, generating the shockwave, the shockwave propagates through the component 1. The portion of the shockwave that propagates through the material 8 filling the recess 4 is incident upon and reflected from the recess walls 6. This causes the shock front of the shockwave to form a concave (e.g. quasi-spherical) shape that is focused towards the target element 10.

The spherically focused shockwave converges at the location of the target element 10, specifically at the location 18 marked “X” in FIG. 2a, owing to the hemispherical base of the target element 10, which acts to further spherically focus the shockwave. The spherically focused shockwave compresses the target element 10, which creates a localised concentration of energy within the target element 10. The resultant increased pressure and temperature within the compressed deuterium-doped palladium material of the target element 10 may be sufficient to generate conditions necessary for nuclear fusion.

FIG. 2b shows the same system as shown in FIG. 2a, except that there is some misalignment in the incident projectile 14 with respect to the planar face of the input 12 of the component 1 (the misalignment is exaggerated for the purposes of illustration). It will be appreciated that it may not be possible to perfectly align the incident projectile 14 (which may be accelerated to a very high speed) with the input 12 of the component 1, such that misalignment may occur during normal operation.

This misalignment of the incident projectile 14 results in the projectile 14 striking one part of the input 12 of the component 1 before the other. This cause the shockwave generated by the projectile 14 striking the input 12 to propagate in a direction that is not fully perpendicular to the central axis of the component 1. However, the shape of the recess walls 6 still act to spherically focus the shockwave towards the target element 10.

Furthermore, owing to the deuterium fuel being distributed throughout the target element 10, the convergence of the shockwave still occurs within the target element 10 (albeit at a location 18 (marked “X”) that is offset from the central axis of the component 1), thus still creating a localised concentration of energy within the target element 10.

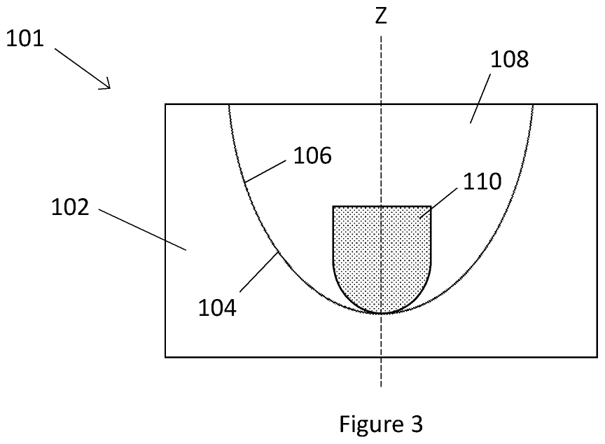

FIG. 3 shows a cross-sectional view of a component 101 in accordance with an embodiment of the invention.

The component 101 shown in FIG. 3 is very similar to the component 1 shown in FIGS. 1a, 1b, 2a and 2b, e.g. the component 101 comprises a body 102 that defines a bowl-shaped recess 104. Similar materials may be used to form the component 101 shown in FIG. 3, as are used for the component 1 shown in FIGS. 1a, 1b, 2a and 2b.

In FIG. 3, a target element 110 is embedded within the material 108 filling the recess 104. The target element 110 has the same part-cylindrical shape as in the component 1 shown in FIGS. 1a, 1b, 2a and 2b.

However, in the component 101 shown in FIG. 3, instead of being spaced from the recess walls 106, the target element 110 is in contact with the recess wall 106 at the base of the recess 104, i.e. at a point on the central axis Z of the component 101.

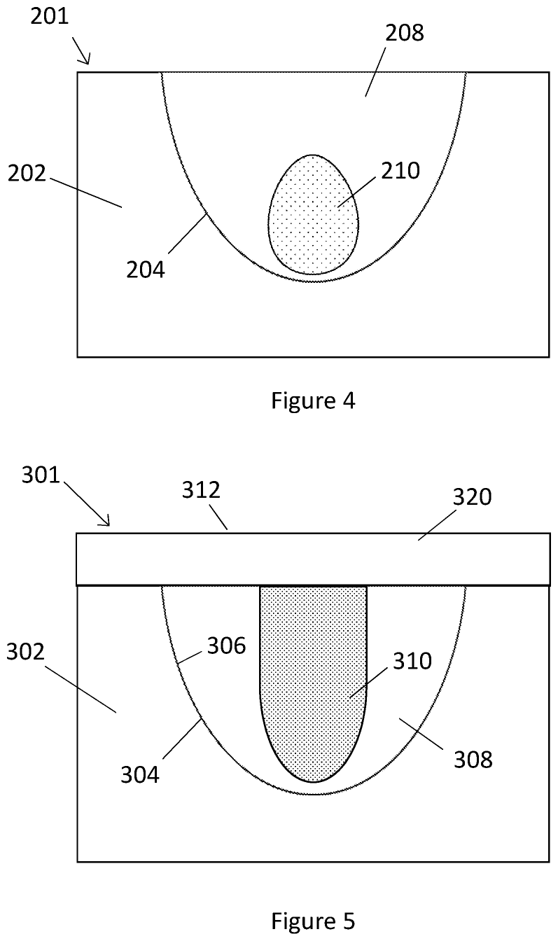

FIG. 4 shows a cross-sectional view of a component 201 in accordance with an embodiment of the invention.

The component 201 shown in FIG. 4 is very similar to the component 1 shown in FIGS. 1a, 1b, 2a and 2b, e.g. the component 201 comprises a body 202 that defines a bowl-shaped recess 204. Similar materials may be used to form the component 201 shown in FIG. 4, as are used for the component 1 shown in FIGS. 1a, 1b, 2a and 2b.

In FIG. 4, a target element 210 is embedded within the material 208 filling the recess 204. In this embodiment, the target element 210 has an ovoidal shape. This shape helps to spherically focus the shockwave as is propagates through the component 201, such that it is focused to a point within the target element 210.

FIG. 5 shows a cross-sectional view of a component 301 in accordance with an embodiment of the invention.

The component 301 shown in FIG. 5 is very similar to the component 1 shown in FIGS. 1a, 1b, 2a and 2b, e.g. the component 301 comprises a body 302 that defines a bowl-shaped recess 304. Similar materials may be used to form the component 301 shown in FIG. 5, as are used for the component 1 shown in FIGS. 1a, 1b, 2a and 2b.

In FIG. 5, a target element 310 is located within the recess 304. The target element 310 has a similar part-cylindrical shape as in the component 1 shown in FIGS. 1a, 1b, 2a and 2b. However, in the embodiment shown in FIG. 5, the component 301 comprises an impedance matching layer 320 that extends across the recess walls 306 at the top of the recess 304, enclosing the interior 308 of the recess 304. The outer surface of the impedance matching layer 320 forms a planar input 312 of the component 301.

The target element 310 is attached to (e.g. supported by) the underside of the impedance matching layer 320. The interior 308 of the recess 304 may be filled with a low shock-impedance material (as in the embodiments shown in FIGS. 1a, 1b, 2a, 2b, 3 and 4) or the interior 308 of the recess 304 may be hollow, e.g. a void in which a vacuum is formed.

In the illustrated embodiment, the impedance matching layer 320 is formed from a high shock-impedance material (such as such as tantalum, tungsten, platinum, steel or copper) and matched to the incident projectile. The impedance matching layer 320 thus helps to couple the shockwave, generated upon the incident projectile striking the input 312 of the component 301, into the component 301. This helps to improve the energy that is transferred from the incident projectile to the component 301 and, ultimately, that is focused and concentrated towards the target element 310. In other embodiments, the impedance matching layer 320 may be formed of low shock-impedance material, such as PMMA or epoxy resin.

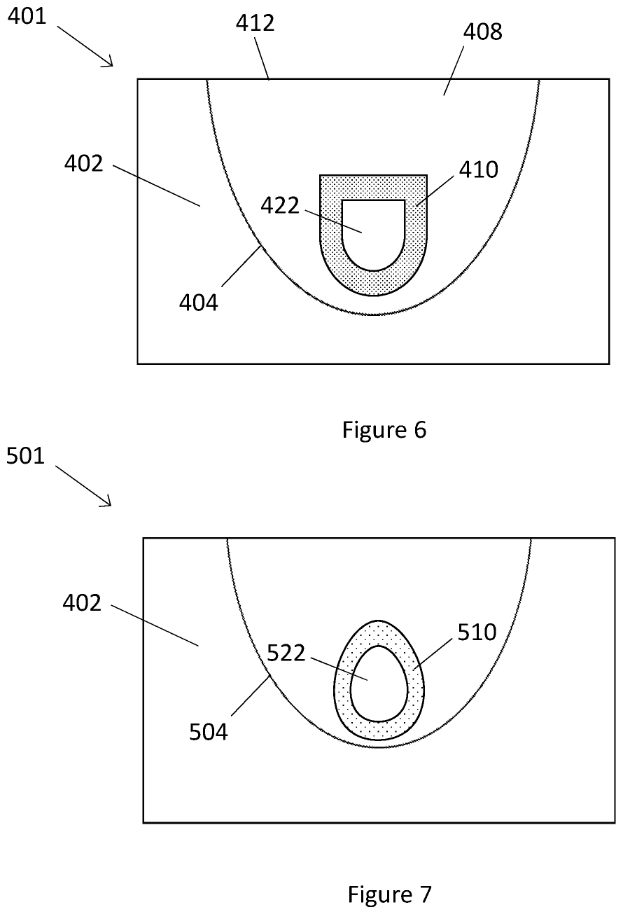

FIG. 6 shows a cross-sectional view of a component 401 in accordance with an embodiment of the invention.

The component 401 shown in FIG. 6 is very similar to the component 1 shown in FIGS. 1a, 1b, 2a and 2b, e.g. the component 401 comprises a body 402 that defines a bowl-shaped recess 404. Similar materials may be used to form the component 401 shown in FIG. 6, as are used for the component 1 shown in FIGS. 1a, 1b, 2a and 2b.

In FIG. 6, a target element 410 is embedded within the material 408 filling the recess 404. The target element 410 has the same part-cylindrical shape as in the component 1 shown in FIGS. 1a, 1b, 2a and 2b. However, in the component 401 shown in FIG. 6, the target element 410 contains a cavity 422 at its centre.

In some embodiments, the cavity 422 is a void in which a vacuum is formed. In some embodiments, the cavity 422 is filled with a (e.g. deuterium-containing, e.g. deuterium-doped) palladium powder, e.g. with deuterium gas between the interstitial gaps of the powder.

In operation, a shockwave (e.g. generated by a projectile striking the input 412 of the component 401) propagates through the component 401 and is spherically focused by the recess 404. The focused shockwave is incident upon the target element 410. This compresses the deuterium-doped palladium material of the target element 410, which collapses into the cavity 422. This helps to intensify the localised concentration of energy within the target element 410.

When the cavity 422 contains fuel, e.g. in the deuterium-doped palladium powder and/or the deuterium gas between the interstitial gaps of the powder, the fuel in the cavity 422 provides additional fuel onto which the deuterium-doped palladium material of the target element 410 collapses.

FIG. 7 shows a cross-sectional view of a component 501 in accordance with an embodiment of the invention.

The component 501 shown in FIG. 7 is very similar to the component 201 shown in FIG. 4, e.g. the component 501 comprises a body 502 that defines a bowl-shaped recess 504. Similar materials may be used to form the component 501 shown in FIG. 7, as are used for the component 1 shown in FIGS. 1a, 1b, 2a and 2b.

In FIG. 7, a target element 510 is embedded within the material 508 filling the recess 504. The target element 510 has the same ovoidal shape as in the component 201 shown in FIG. 4. However, similarly to the component 401 shown in FIG. 6, in the component 501 shown in FIG. 7, the target element 510 contains a cavity 522 at its centre.

As with the component 401 shown in FIG. 6, the cavity 522 within the target element 510 helps to intensify the localised concentration of energy within compressed deuterium-doped palladium material of the target element 510.

In some embodiments, the cavity 522 is a void in which a vacuum is formed. In some embodiments, the cavity 522 is filled with a (e.g. deuterium doped) palladium powder, e.g. with deuterium gas between the interstitial gaps of the powder.

The applicant has observed that in some embodiments, a high pressure jet forms at the “south pole” of the component (i.e. below the focusing element). The jetting is caused by the portions of the shock travelling from different directions (e.g. along the recess walls) overlapping.

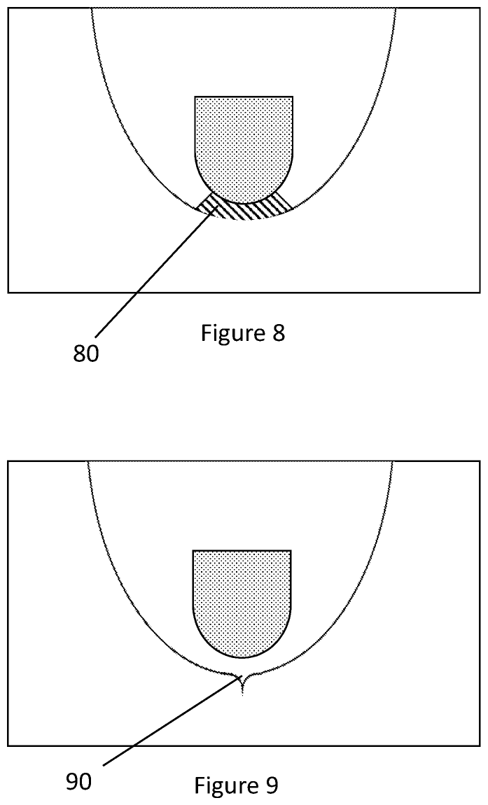

FIGS. 8 and 9 show variants of the component of FIG. 1 which are designed to mitigate this jetting effect.

The component of FIG. 8 comprises a shaped impedance matched layer 80 which is placed between the focusing element and cavity wall at the south pole. This layer 80 acts to slow the formation of any jet. In the illustrated embodiment, the shaped impedance matched layer 80 is formed of a material having a having a high shock-impedance such as tantalum, tungsten, platinum, steel or copper. In some embodiments, however, the shaped impedance matched layer 80 may be formed of low shock-impedance material, such as PMMA or epoxy resin.

The component of FIG. 9 has a recess wall which is shaped to provide a depression 90 at the south pole. This depression results in a reduction of pressure upon shock overlap which may reduce the effect of jetting.

It will be understood that these anti-jetting designs may also be incorporated into the other components described herein.

Although specific examples have been given, it will be appreciated that there are a large number of parameters that may influence the actual results achieved.

In the embodiments described above, some of the diagrams shown are a vertical cross-section through a three-dimensional component and hence they depict embodiments that are rotationally symmetric. However, this is not essential to the invention.

It will be understood that the embodiments explicitly disclosed herein are intended to be exemplary, and the skilled person will understand that features of the embodiments disclosed herein may, except where mutually exclusive, be combined in combinations not explicitly mentioned in order to form new embodiments.

Although the input faces of the components shown in the illustrated embodiments are planar, it will be appreciated that embodiments exist in which the input face of the component is at least partially non-planar, e.g. curved, e.g. convex or concave. Similarly, although the projectiles shown in the illustrated embodiments are planar, it will be appreciated that embodiments exist in which the (e.g. impact face of the) projectile is at least partially non-planar, e.g. curved, e.g. convex or concave.

Embodiments of the invention may be suitable for amplifying shockwaves for the purpose of generating conditions suitable for nuclear fusion; however, the invention is not limited to this, and may be used for other applications.

1. A component for compressing fuel using an input shockwave, the component comprising:
a body comprising a recess wall defining a recess;
an input for inputting the input shockwave into the component; and
a target element within the recess;
wherein the target element comprises a fuel-containing material; and
wherein the component is configured to manipulate the input shockwave to provide a localised concentration of energy within the target element.

2. The component as claimed in claim 1, wherein the fuel-containing material comprises fuel that is dispersed throughout the fuel-containing material.

3. The component as claimed in claim 1, wherein the fuel-containing material comprises a bulk material;
wherein the bulk material is not fuel;
wherein fuel is contained among the bulk material; and
wherein the fuel is not chemically bonded to the bulk material.

4. The component as claimed in claim wherein the fuel-containing material comprises a fuel-doped material.

5. The component as claimed in claim 1, wherein the fuel-containing material comprises a mixture containing the fuel.

6. The component as claimed in claim 1, wherein the fuel comprises a fusionable fuel.

7. The component as claimed in claim 1, wherein the body comprises a first material;
wherein the recess contains a second material; and
wherein the second material has a lower shock-impedance than the shock-impedance of the first material.

8.-10. (canceled)

11. The component as claimed in claim 1, wherein the target element is a unitary element, formed from the fuel-containing material.

12. The component as claimed in claim 1, wherein the body comprises a first material;
wherein the recess contains a second material; and
wherein the fuel-containing material has a higher shock-impedance than the second material.

13. The component as claimed in claim 1, wherein the body comprises a first material;
wherein the recess contains a second material; and
wherein the target element is contained within the second material.

14.-16. (canceled)

17. The component as claimed in claim 1, wherein the component further comprises a central axis and is configured to receive an input shockwave propagating in a direction parallel to the central axis;
wherein the target element has a first maximum dimension parallel to the central axis, and a second maximum dimension perpendicular to the central axis;
wherein the first maximum dimension is greater than the second maximum dimension.

18. The component as claimed in claim 1, wherein the target element comprises a cavity defined within the target element.

19. The component as claimed in claim 18, wherein the cavity comprises a fuel.

20. The component as claimed in claim 18, wherein the cavity comprises a powder.

21. The component as claimed in claim 20, wherein the cavity comprises a fuel in the gaps between the powder.

22. The component as claimed in claim 18, wherein the cavity comprises substantially a vacuum.

23. The component as claimed in claim 1, wherein the component further comprises at least one impedance matching layer adjacent to or at the input of the component.

24.-25. (canceled)

26. A method of compressing fuel using an input shockwave, the method comprising generating the input shockwave at the input of a component according to claim 1.

27. A system for compressing fuel using an input shockwave, the system comprising:
a component as claimed in claim 1; and
a mechanism for generating the input shockwave at the input of the component.

28. The system as claimed in claim 27, wherein the mechanism comprises:
a driving mechanism configured to drive a projectile into the component to generate a shockwave at the input of the component.
